(19) United States
(12) Patent Application Publication
(10) Pub. No.: US 2008/0148414 A1
(43) Pub. Date: Jun. 19, 2008

(54) PORTABLE DIGITAL RIGHTS MANAGEMENT (DRM)

(75) Inventor: Joe Yuen Tom, Foster City, CA (US)

Correspondence Address: AMIN, TUROCY & CALVIN, LLP, 1900 EAST NINTH STREET, 24TH FLOOR, NATIONAL CITY CENTER, CLEVELAND, OH, 44114, US

(73) Assignee: SPANSION LLC, Sunnyvale, CA (US)

(21) Appl. No.: 11/612,874

(22) Filed: Dec. 19, 2006

(51) Int. Cl. G06F 17/30

(52) U.S. Cl. 726/29

(57) ABSTRACT

An architecture is presented that facilitates the transfer of content and rights from a network device to a non-network device. The system comprises a trusted digital rights management (DRM) agent/server that is associated with a network device. The trusted DRM agent/server communicates with a non-network device to transfer content and rights. Specifically, the trusted DRM agent/server of the network device communicates with a second trusted DRM agent/server associated with the non-network device. The trusted DRM agent/server mutually authenticates the second trusted DRM agent/server in order to extend the DRM content and rights provided by the content providers. After mutual authentication, the trusted DRM agent/server transfers rights and contents to the second trusted DRM agent/server. Once the rights and content are transferred, the original copy of the content is guaranteed to be deleted from the trusted DRAM agent/server to preserve the current license rights of the content.

### BACKGROUND

Media distribution systems distribute media content to client electronic devices (e.g., an MP3 player, an iPod®, a cellular phone, a personal digital assistant (PDA), a portable media player, etc.) from a media server. A media distribution system may distribute media content by allowing a user to download media data files and/or receive and process media data streams.

When media data files are traditionally downloaded to a user's client electronic device, each media data file downloaded is licensed for exclusive use on the user's client electronic device, such that the usage rights (associated with the downloaded media data file) are passed to the client electronic device at the time that the media data file is downloaded.

Often, a user of a first client electronic device may wish to share a media data file (e.g. a song, a video file or a text file) with a user of a second client electronic device. Unfortunately, as the media data files are licensed for exclusive use on a specific client electronic device, the media data file may not be directly transferred from the first client electronic device to the second client electronic device. Accordingly, the user of the second client electronic device would typically be required to obtain the media data file directly from the media distribution system.

Therefore, there is a continuing need to be able to transfer media data files from a first client electronic device to a second client electronic device without obtaining the media data file directly from the media distribution system.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a system that facilitates the transfer of content and rights from a network device to a non-network device. The system comprises a trusted digital rights management (DRM) agent/server that is associated with a network device. The trusted DRM agent includes a downloadable agent component and a server component. The DRM server component is responsible for content packaging and transfer. The DRM agent component is responsible for enforcing DRM rules and managing content access via content license and policy management. The DRM agent component and the DRM server component are integrated to form a trusted DRM agent that communicates with a non-network device to transfer, content and rights. Once the rights and content are transferred, the original copy of the content is guaranteed to be deleted to preserve the current license rights of the content

Further, the trusted DRM agent of the network device communicates with a second trusted DRAM agent associated with the non-network device. The second trusted DRM agent enables the non-network device to become a trusted platform for receiving DRM content and rights. The trusted DRM agent mutually authenticates the second trusted DRM agent in order to extend the DRM content and rights provided by the content provider. After mutual authentication, the trusted DRM agent transfers rights and contents to the second trusted DRM agents. The non-network device becomes a secure platform and is then able to access the transferred content via the second trusted DRM agent. Once the rights and content are transferred, the original copy of the content is guaranteed to be deleted from the trusted DRM agent to preserve the current license rights of the content.

In another aspect of the claimed subject matter, a system is provided wherein transfer of DRM content and rights is managed in a secure environment. The system includes a memory module that creates the secure environment. The memory module comprises a security processor, non-volatile memory and volatile memory. Furthermore, the non-volatile memory of the memory module stores security software for use by the security processor. The security processor provides for concurrent processing of security protocols creating the secure environment within the memory module and communicates with a limited function trusted DRM agent located within the memory module. The limited function trusted DRM agent communicates with a non-network device to transfer rights and content. Accordingly, the limited function trusted DRM agent is located within the memory module such that the transfer of content and rights is managed in the secure environment.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of a system that facilitates the transfer of content and rights.

FIG. 2 illustrates a block diagram of a system that facilitates the transfer of content and rights from a network device to a non-network device.

FIG. 3 illustrates a block diagram of a trusted DRM agent within a portable device.

FIG. 4 illustrates a block diagram of a system wherein the trusted DRM agent is located within the secure environment of a memory module.

FIG. 5 illustrates a flow chart of a method for facilitating the transfer of content and rights from a network device to a non-network device.

FIG. 6 illustrates a flow chart of a method for facilitating the transfer of content and rights from a first trusted DRM agent to a second trusted DRM agent.

FIG. 7 illustrates a flow chart of a method of managing the transfer of content and rights in a secure environment.

FIG. 8 illustrates a block diagram of a computer operable to execute the disclosed transfer of content and rights architecture.

FIG. 9 illustrates a schematic block diagram of an exemplary computing environment for use with the disclosed transfer of content and rights system.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Additionally, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer-readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Digital rights management (DRM) rights and objects are often bonded to a platform and restricted from moving to another platform. This restriction is due to the fact that typically current platforms are not trusted and/or authenticated by the content provider. A content provider would not extend its services to a platform that is not trusted. Thus, a user of a client electronic device can not transfer downloaded media content to a second client electronic device without first acquiring license rights from the content provider. For example, music downloaded to a player is not allowed to move into another player. Thus, a user of the second client electronic device would typically be required to obtain the downloaded media content directly from the content provider. Accordingly, the following subject matter enables the transfer of DRM content and rights from a network device to a non-network device.

A trusted digital rights management (DRM) agent that facilitates the transfer of content and rights is disclosed. The trusted DRM agent communicates with a non-network device via a second trusted DRM agent. The two trusted DRM agents are mutually authenticated, allowing for the transfer of content and rights to the non-network device. Once the content and rights are transferred, the original copy is deleted from the network device via the trusted DRM agent to preserve the current license rights of the content.

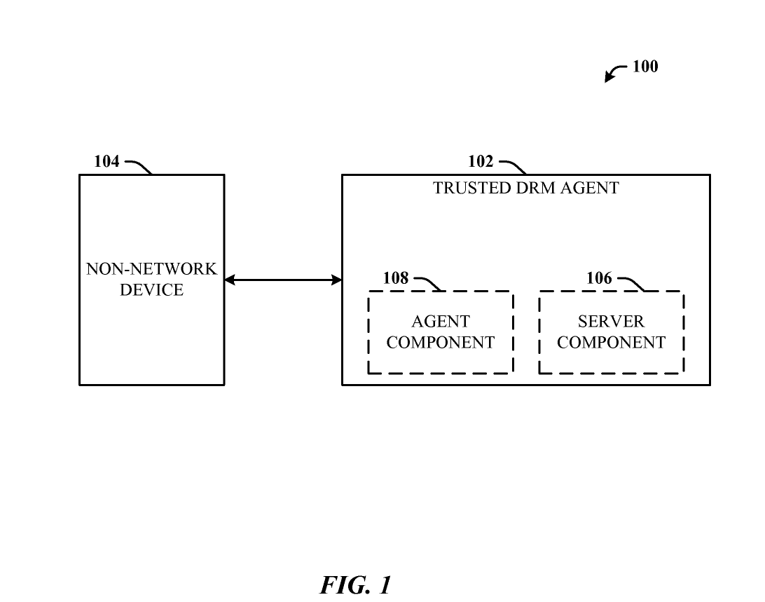

Referring initially to the drawings, FIG. 1 illustrates a system 100 that facilitates the transfer of content and rights from a network device to a non-network device. The system 100 includes a trusted digital rights management (DRM) agent/server 102 that is associated with a network device (not shown). DRM is a term that refers to any of several technologies used by publishers or copyright owners to control access to and usage of digital data or hardware, and to restrictions associated with a specific instance of a digital work or device.

The DRM system 100 for facilitating transfer of content and rights is based on an agent-server DRM architecture that enables integration with various platforms. The trusted DRM agent 102 includes a downloadable agent component 108 and a server component 106. The DRM server component 106 is designed to sit in front of a standard content management and distribution system, allowing seamless integration of DRM content into existing content management systems. The DRM server component 106 is responsible for content packaging and transfer and performs the full authentication process with the connected device. Specifically, the DRM server component 106 verifies data during transfer and removes the content from the source after the transfer is completed. The DRM server component 106 is suitable for use, over any type of standard Internet network connection. The agent and server architecture is generic and modular and can easily be extended to cover other DRM schemes if required.

The DRM agent component 108 is part of a downloadable software application. It can be customized and integrated with existing music/media player and media manager components, or it can be deployed with generic and customizable manager and player components as necessary. The DRM agent component 108 is responsible for enforcing DRM rules and managing content access via content license and policy management. The DRM agent component 108 and the DRM server component 106 are integrated to form a trusted DRM agent 102 that communicates with a device 104 to transfer content and rights.

Typically, the trusted DRM agent 102 is an application specific integrated circuit (ASIC) designed for transferring DRM rights and content. The device 104 is any portable or fixed location device, such as a media player. The device 104 can be networked connected or stand alone, (i.e., not connected to a network, such as a car stereo. The system 100 creates a trusted DRM agent 102 that is allowed to transfer rights and contents to the device 104. Transfer of the rights and content occurs via cable, removable card or wireless link. Once the rights and content are transferred, the original copy of the content is guaranteed to be deleted to preserve the current license rights of the content.

If the transfer is between two different but supported DRM standards, DRM rights and content may be converted, allowing the transfer of rights and content to the device. The trusted DRM agent 102 can support one or more DRM standards and can perform the rights and format conversion if needed. Specifically, there are several DRM standards, such as Microsoft Media DRM 10 (WMA)®, RealNetworks Helix DRM (RM)®, Apple FairPlay DRM (ACC)®, Sony MagicGate (ATRAC3)®, and MPEG-21 (MPEG4)®. Accordingly, a user may transfer DRM (rights and content) within the same DRM standard. For example, a user may transfer songs from a, portable Microsoft Media Player®, which acquires DRM content when connected to a Personal Computer (PC) to a Microsoft® car stereo media player which is not network connected.

A user may also transfer DRM (rights and content between non-compatible DRM standards, such as from an IPOD to a Microsoft® media player. Thus, DRM format may be converted front one standard to another and then transferred to a device, as long as permission is received from the provider (i.e., the accompanied DRM rights allow the transfer). If the permission is not already specified in the DRM rights, the user must seek additional approval directly from the provider. Accordingly, the portable DRM controller enables the implementation of DRM content on a music player (or other device) that must comply with several DRM standards.

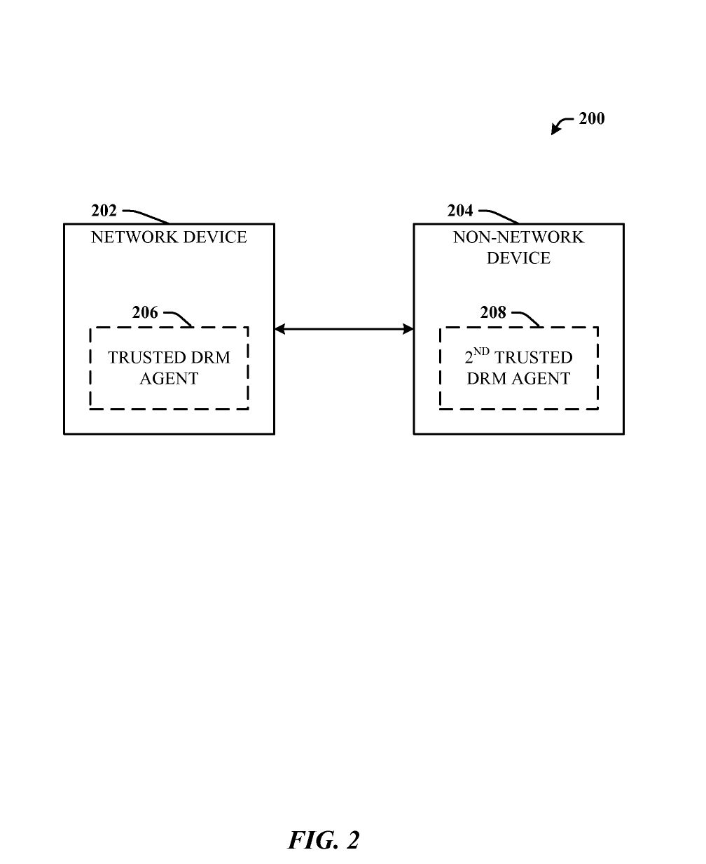

In more detail, FIG. 2 illustrates the system 200 wherein content and rights are transferred from a network device 202 to a non-network device 204. The network device 202 comprises at least one of a multimedia player, a personal digital assistant (PDA), a cell phone, an iPod®, an MP3 player, a portable media player and a hand held computing device. It is thus to be understood that any suitable computing device capable of connection to a network and capable of receiving DRM content and rights is contemplated and intended to fall under the scope of the hereto-appended claims.

As stated supra, the non-network device 204 is any device that is not connected to a network, such as a car stereo. It is thus to be understood that any suitable device capable of receiving DRM content and rights is contemplated and intended to fall tinder the scope of the hereto-apppended claims. Typically, the non-network device 204 is not a trusted platform for receiving the DRM content and rights. The network device 202 is a trusted platform due to the trusted DRM agent 206 that is associated with the network device 202. The trusted DRM agent 206 is authenticated and registered with a content provider (not shown). The trusted DRM agent 206 acquires a license and receives content via the content provider. However, the trusted DRM agent 206 intends to transfer these rights and content to another device, (i.e. the non-network device).

Accordingly, the trusted DRM agent 206 of the network device 202 communicates with a second trusted DRM agent 208 of the non-network device 204. The trusted DRM agent 206 and the second trusted DRM agent 208 have compatible hardware so that they are able to communicate with each other. Further, the trusted DRM agent 206 mutually authenticates the second trusted DRM agent 208 in order to extend the DRM content and rights provided by the content provider. Mutual authentication is provided via at least one of password authentication, shared key authentication, public key infrastructure (PKI) authentication, and any other type of authentication process available.

After mutual authentication, the trusted DRM agent 206 transfers rights and contents to the second trusted DRM agent 208. The non-network device 204 becomes a secure platform and is then able to access the transferred content via the second trusted DRM agent 208. Once the rights and content are transferred, the original copy of the content is guaranteed to be deleted from the trusted DRM agent 206 to preserve the current license rights of the content.

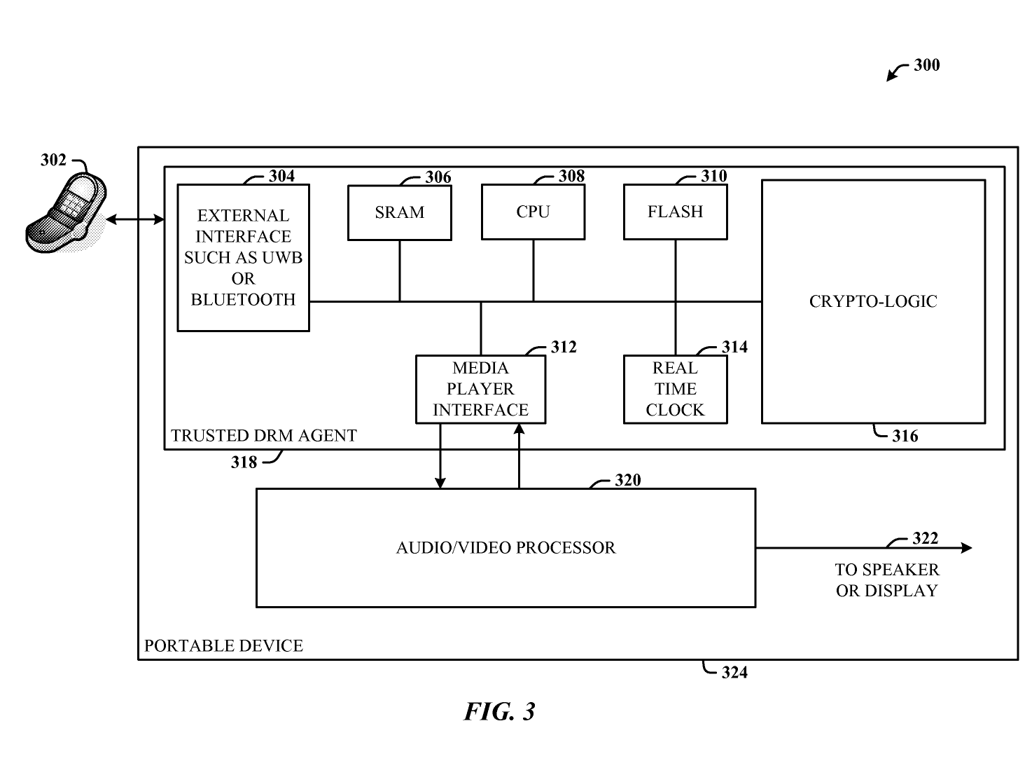

In more detail, FIG. 3 illustrates the components of a trusted DRM agent within a portable device 300. The trusted DRM agent 318 is an ASIC designed for transferring DRM rights and content. The trusted DRM agent 318 includes a central processing unit (CPU) 308 or any other type of low power application processor. The CPU 308 within the trusted DRM agent 318 can manage the memory storage 306 and provide a secure environment for managing the transfer of content and rights.

The trusted DRM agent 318 also includes a flash memory 310 for secondary storage of DRM rights processing. Further, the trusted DRM agent 318 includes crypto-logic 316 that performs all the cryptographic algorithms, symmetric and a-symmetric needed by the trusted DRM agent 318. The CPU 308 configures the crypto-logic 316 and can control the data flow through the trusted DRM agent 318.

A real time clock 314 is also included for time limited DRM enforcement. Further, an external interface 304 (i.e., Ultra-Wideband (UWB) or Bluetooth) communicates with the rights and content that are to be transferred from a portable device 302. Finally, a media player interface 312 communicates with the audio/video processor 320 of the portable device 324 for processing and transferring of the DRM rights and content. Once the rights and content have been transferred, the content is transferred to a speaker or display 322 for use by the user.

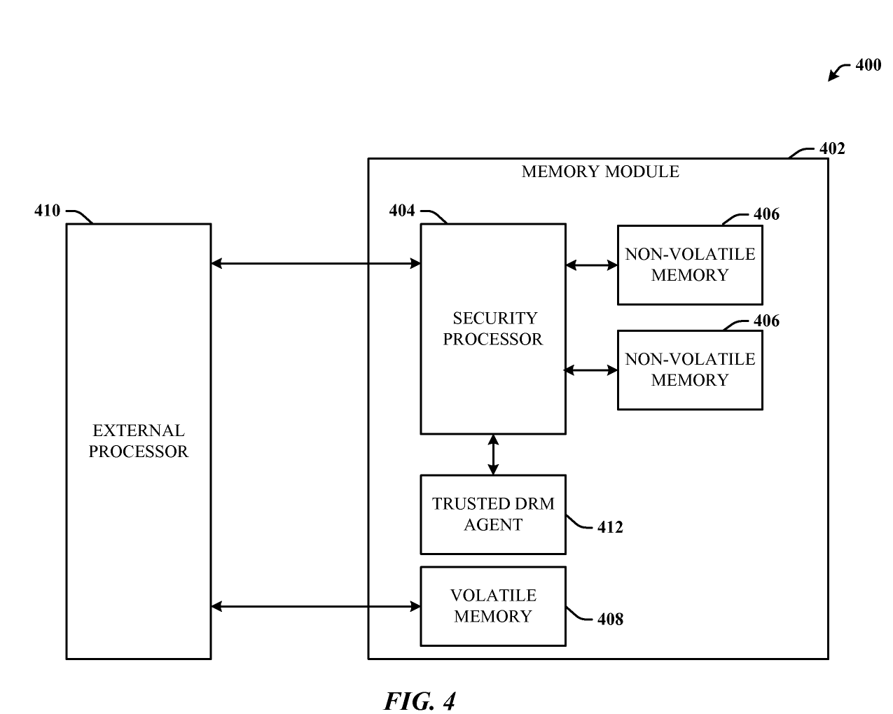

FIG. 4 illustrates a system 400 wherein transfer of DRM content and rights is managed in a secure environment. The system 400 includes a memory module 402 that creates the secure environment. The memory module 402 is a package of multiple chips or integrated circuits, wherein one integrated circuit houses a security processor 404 and another integrated circuit houses non-volatile memory 406. The integrated circuits are then coupled together to form the memory module 402.

Furthermore, the non-volatile memory 406 of the memory module 402 stores security software for use by the security processor 404. The non-volatile memory 406 is typically flash memory, but can be any type of non-volatile memory typically used for the task of secondary storage, or long-term persistent storage. Furthermore, one or more non-volatile memory 406 can be included in the memory module 402. If more than one non-volatile memory 406 is included, the non-volatile memory 406 is not required to be of the same type and/or density.

The security software includes password authentication software, shared key authentication software, public key infrastructure (PKI) authentication software, integrity check software, encryption/decryption software, anti-virus software, anti-spyware software, secure communication software, and any other type of security software available. The security software is directly embedded into the non-volatile memory 406 to provide integrated security capabilities within the memory module 402. The security processor 404 accesses the security software from the non-volatile memory 406 and performs security functions based on the specific security software stored. The security processor 404 controls the entire non-volatile memory storage and monitors all traffic to and from the non-volatile memory components 406.

The memory module 402 also includes volatile memory or random access memory (RAM) 408. The volatile memory 408 is used for primary storage and communicates with an external processor 410. Furthermore, the memory module 402 communicates with the external processor 410 via a split or shared bus, such as a NOR and NAND bus, to facilitate integrated security capabilities. If more than one bus is utilized, both can be functioning in parallel. The external processor 410 is a typical applications processor that handles communications and runs applications. The external processor 410 can be a baseband processor or application processor for a mobile handset, PDA, or the like.

The security processor 404 provides for concurrent processing of security protocols creating the secure environment within the memory module 402 and communicates with a limited function trusted DRM agent 412 located within the memory module 402. The limited function trusted DRM agent 412 communicates with a non-network device (not shown) to transfer rights and content. Once the rights and content are transferred, the original copy of the content is guaranteed to be deleted from the limited function trusted DRM agent 412 to preserve the current license rights of th content. Accordingly, the limited unction trusted DRM agent 412 is located within the memory nodule 402 such that the transfer of content and rights is managed in a secure environment.

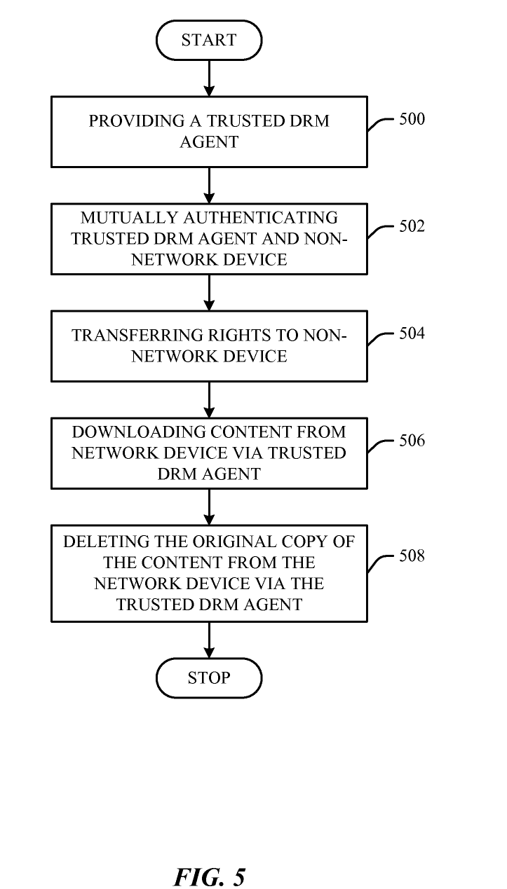

FIGS. 5-7 illustrate methodologies for facilitating the transfer of content and rights from a network device to a non-network device according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 5, a method for facilitating the transfer of content and rights from a network device to a non-network device is illustrated. At 500, a trusted DRM agent is provided. The trusted DRM agent is authenticated and registered with a content provider. The trusted DRM agent is an application specific integrated circuit (ASIC) designed for transferring DRM rights and content to a non-network device. The non-network device is any device that is not connected to a network such as a car stereo. At 502, the trusted DRM agent and the non-network device are mutually authenticated. Mutual authentication is provided via at least one of password authentication, shared key authentication, public key infrastructure (PKI) authentication, and any other type of authentication process available.

At 504, the rights are transferred to the non-network device. Once the rights are transferred to the non-network device, the non-network device is able to receive the content. At 506, the content is downloaded from the network device via the trusted DRM agent. The non-network device becomes a secure platform and is then able to access the transferred content. And at 508, the original copy of the content is deleted from the network device via the trusted DRM agent. The original copy is deleted to preserve the current license rights of the content.

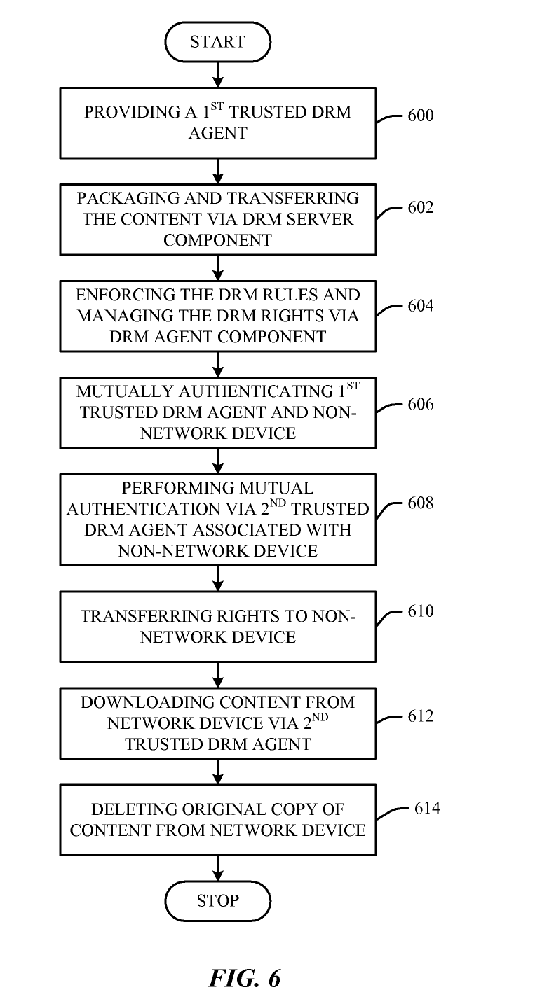

Referring to FIG. 6, a method for facilitating the transfer of content and rights from a first trusted DRM agent to a second trusted DRM agent is illustrated. At 600, a first trusted DRM agent is provided. The first trusted DRM agent is authenticated and registered with a content provider. The first trusted DRM agent includes a downloadable agent component and a server component. At 602, the content is packaged and transferred via the DRM server component. The DRM server component is designed to sit in front of a standard content management and distribution system, allowing seamless integration of DRM content into existing content management systems. The DRM server component is responsible for content packaging and transfer. The DRM server component is suitable for use over any type of standard Internet network connection.

At 604, DRM rules are enforced and the rights associated with the content are managed via the DRM agent component. The DRM agent component is part of a downloadable software application. It call be customized and integrated with existing music/media player and media manager components, or it can be deployed with generic and customizable manager and player components as necessary. The DRM agent component is responsible for enforcing DRM rules and managing content access via content license and policy management. The DRM agent component and the DRM server component are integrated to form the first trusted DRM agent that communicates with a non-network device to transfer content and rights.

At 606, the first trusted DRM agent and the non-network device are mutually authenticated. Mutual authentication is provided via at least one of password authentication, shared key authentication, public key infrastructure (PKI) authentication, and any other type of authentication process available. At 608, the mutual authentication of the first trusted DRM agent and the non-network device is performed via a second trusted DRM agent associated with the non-network device. Typically the non-network device is not a trusted platform for receiving the DRM content and rights. The network device is a trusted platform due to the first trusted DRM agent that is associated with the network device. Accordingly, the first trusted DRM agent of the network device communicates with a, second trusted DRM agent of the non-network device. The first trusted DRM agent and the second trusted DRM agent have compatible hardware so that they are able to communicate with each other. Further, the first trusted DRM agent initially authenticates the second trusted DRM agent in order to extend the DRM content and rights provided by the content provider. After mutual authentication, the first trusted DRM agent transfers rights and contents to the second trusted DRM agent.

At 610, the rights are transferred to the non-network device via the first and second trusted DRM agents. Once the rights are transferred to the non-network device, the non-network device is able to receive the content. At 612, the content is downloaded from the network device via the second trusted DRM agent. The non-network device becomes a secure platform and is then able to access the transferred content via the second trusted DRM agent. And at 614, the original copy of the content is deleted from the network device via the first trusted DRM agent. Once the rights and content are transferred, the original copy of the content is guaranteed to be deleted from the network device via the first trusted DRM agent to preserve the current license rights of the content.

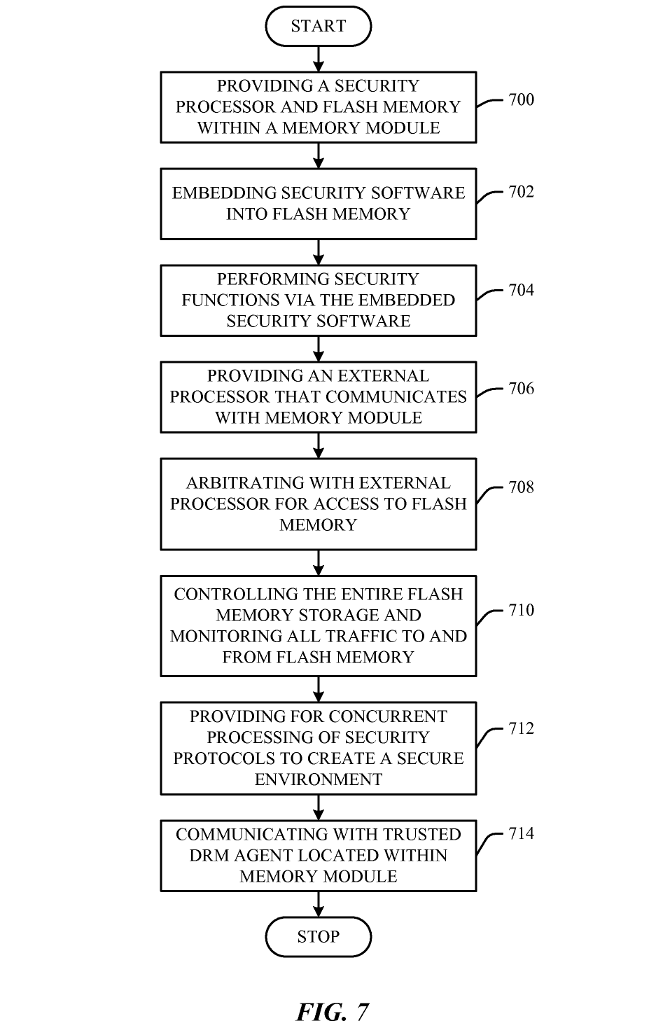

Referring to FIG. 7, a method of managing the transfer of content and rights in a secure environment is illustrated. At 700, a security processor and flash memory are provided within a memory module. The memory module is a package of multiple chips or integrated circuits, wherein one integrated circuit houses the security processor and another integrated circuit houses the flash memory. The integrated circuits are then coupled together to form the memory module. At 702, security software is embedded into the flash memory. The security software includes password authentication software, shared key authentication software, PKI authentication software, integrity check software, encryption/decryption software, anti-virus software, anti-spyware software, etc. It is thus to be understood that any suitable security software and algorithms are contemplated and intended to fall under the scope of the hereto-appended claims.

At 704, security functions are performed via the embedded security software. And at 706, an external processor is provided that communicates with the memory module. The security processor of the memory module sits in series with the external processor and the flash memory. At 708, the security processor arbitrates with the external processor for access to the flash memory. The security processor manages the flash memory and provides a secure environment to manage the transfer of content and rights. At 710, the security processor controls the entire flash memory storage and monitors all traffic to and from the flash memory components.

At 712, the security processor provides for concurrent processing of security protocols creating the secure environment within the memory module. At 714 the security processor communicates with a trusted DRM agent located within the memory module. The trusted DRM agent is typically a limited function trusted DRM agent that communicates with a non-network device to transfer rights and content. Accordingly, the trusted DRM agent is located within the memo I module such that the transfer of content and rights is managed in a secure environment.

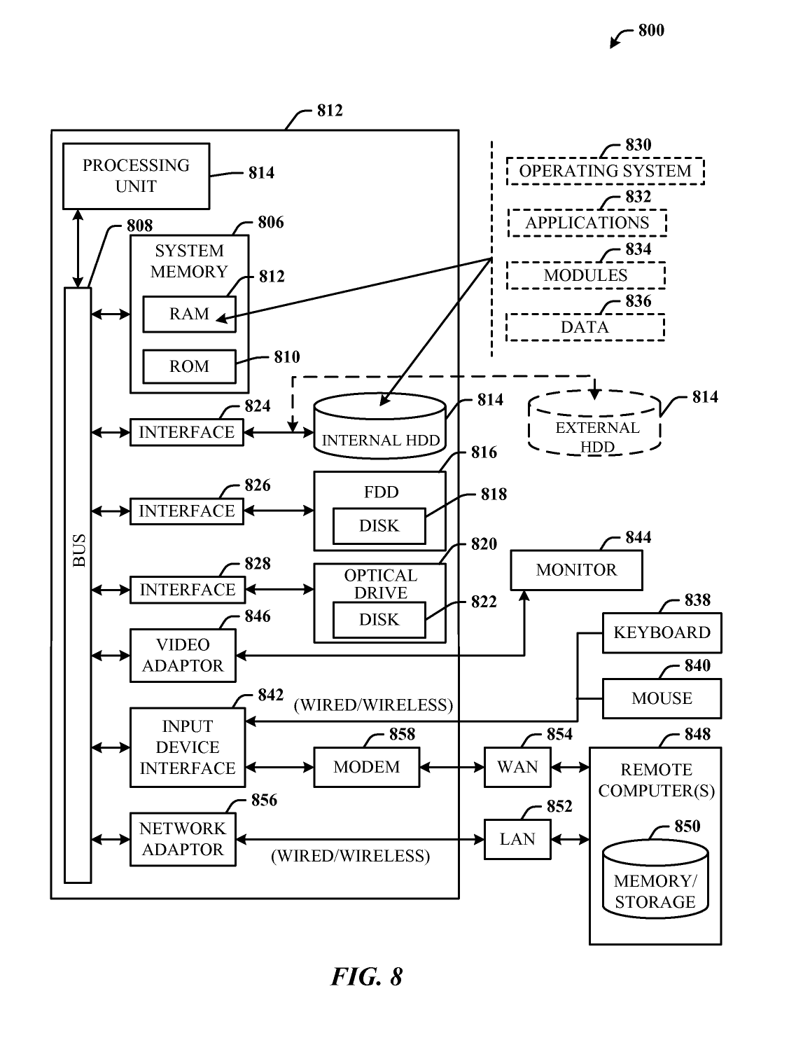

Referring now to FIG. 8, there is illustrated a block diagram of a computer operable to execute the disclosed transfer of content and rights architecture. In order to provide additional context for various aspects thereof, FIG. 8 and the following discussion are intended to provide a brief, general description of a suitable computing environment 800 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the innovation can be implemented with various commercially available operating systems or combinations of operating systems.

A user can enter commands and information into the computer 802 through one or more wired/wireless input devices (e.g., a keyboard 838 and a pointing device, such as a mouse 840). Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks (e.g., a wide area network (WAN) 854). Such LAN and WAN networking environments are commonplace in offices and companies, and facilitate enterprise-wide computer networks, such as intranets, all of which may connect to a global communications network (e.g., the Internet).

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices (e.g., computers) to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

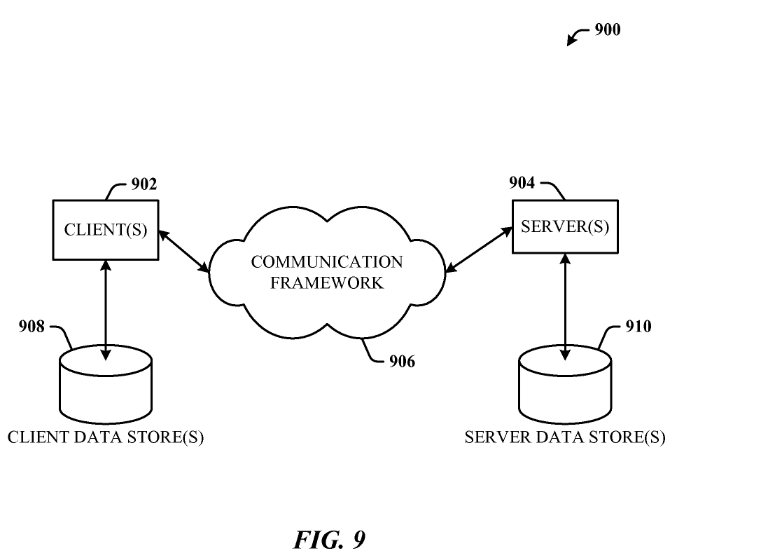

Referring now to FIG. 9, there is illustrated a schematic block diagram of an exemplary computing environment 900 in accordance with another aspect. The system 900 includes one or more client(s) 902. The client(s) 902 can be hardware and/or software (e.g., threads, processes, computing devices). The client(s) 902 can house cookie(s) and/or associated contextual information by employing the subject innovation, for example.

The system 900 also includes one or more server(s) 904. The server(s) 904 can also be hardware and/or software (e.g., threads, processes, computing devices). The servers 904 can house threads to perform transformations by employing the invention, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g. a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that facilitates the transfer of content and rights from a network device to a second device, comprising:
a first trusted digital rights management (DRM) agent that mutually authenticates a second trusted DRM agent of the second device and transfers rights and content to the second trusted DRM agent.

2. The system of claim 1, wherein the first trusted DRM agent comprises a server component and an agent component, the server component packages and transfers the content and the agent component enforces DRM rules and manages the rights associated with the content.

3. The system of claim 1, wherein the first and second trusted DRM agents have compatible hardware.

4. The system of claim 1, wherein the first trusted DRM agent deletes an original copy of the content after transferring the content to the second trusted DRM agent.

5. The system of claim 1, wherein the first trusted DRM agent is authenticated and registered with a content provider.

6. The system of claim 1, wherein the first trusted DRM agent is located within a memory module, the memory module comprises a security processor that communicates with the first trusted DRM agent and non-volatile memory to establish a secure environment, such that transfer of the content and rights is managed in the secure environment.

7. The system of claim 1, wherein the mutual authentication between the first and second trusted DRM agents occurs via at least one of password authentication, shared key authentication and public key infrastructure (PKI) authentication.

8. The system of claim 1, wherein the first trusted DRM agent is an application specific integrated circuit (ASIC).

9. The system of claim 8, wherein the first trusted DRM agent comprises a central processing unit (CPU), memory, crypto-logic and an embedded agent/server in firmware.

10. The system of claim 1, wherein the network device comprises at least one of a multimedia player, a Personal Digital Assistant (PDA), a cell phone, a portable media player, an MP3 player, and a hand held computing device.

11. The system of claim 1, wherein the content comprises at least one of downloaded audio, video and text.

12. A method for facilitating the transfer of content and rights from a network device to a non-network device, comprising:
providing a first trusted DRM agent that is authenticated and registered with a content provider;
mutually authenticating the first trusted DRM agent and the non-network device;
transferring rights to the non-network device;
downloading the content from the network device via the first trusted DRM agent; and
deleting an original copy of the content from the network device via the first trusted DRM agent.

13. The method of claim 12, wherein mutually authenticating the first trusted DRM agent and non-network device is performed via a second trusted DRM agent associated with the non-network device.

14. The method of claim 13, wherein the first and second trusted DRM agents utilize at least one of password authentication, shared key authentication and PKI authentication.

15. The method of claim 13, further comprising packaging and transferring content via a server component of the first trusted DRM agent; and enforcing DRM rules and managing the rights associated with the content via an agent component of the first trusted DRM agent.

16. The method of claim 12, wherein the first and second trusted DRM agents have compatible hardware.

17. The method of claim 12, further comprising:
providing a security processor and a flash memory within a memory module;
embedding security functionality directly into the flash memory;
performing security functions via the embedded security functionality;
establishing a secure environment via the memory module; and
positioning the first trusted DRM agent within the memory module such that transfer of the content and rights is managed in the secure environment.

18. The method of claim 12, wherein the first trusted DRM agent is an ASIC.

19. The method of claim 18, wherein the first trusted DRM agent comprises a CPU, memory, crypto-logic and an embedded agent/server in firmware.

20. A system that facilitates the transfer of content from a network device to a non-network device, comprising:
means for providing a first trusted DRM agent that is authenticated and registered with a content provider;
means for communicating with a second trusted DRM agent;
means for mutually authenticating the first trusted DRM agent and the second trusted DRM agent, wherein the first trusted DRM agent is associated with the network device and the second trusted DRM agent is associated with the non-network device;
means for transferring content and rights to the non-network device via the first and second trusted DRM agents; and
means for deleting an original copy of the content from the network device via the first trusted DRM agent.
